(19) United States
(12) Patent Application Publication
(10) Pub. No.: US 2013/0046411 A1
(43) Pub. Date: Feb. 21, 2013

(54) Electric Vehicle Load Management

(71) Applicants: Mohammad Abdullah Al Faruque, Plainsboro, NJ (US); Mohsen A. Jafari, Princeton Jct., NJ (US); Hartmut Ludwig, West Windsor, NJ (US); Livio Dalloro, Princeton, NJ (US); Md Ehtesamul Haque, Piscataway, NJ (US)

(72) Inventors: Mohammad Abdullah Al Faruque, Plainsboro, NJ (US); Mohsen A. Jafari, Princeton Jct., NJ (US); Hartmut Ludwig, West Windsor, NJ (US); Livio Dalloro, Princeton, NJ (US); Md Ehtesamul Haque, Piscataway, NJ (US)

(73) Assignee: Siemens Corporation, Iselin, NJ (US)

(21) Appl. No.: 13/572,966

(22) Filed: Aug. 13, 2012

Related U.S. Application Data
(60) Provisional application No. 61/523,500, filed on Aug. 15, 2011.

(51) Int. Cl. G06F 1/26

(52) U.S. Cl. 700/286

(57) ABSTRACT

A distributed and collaborative load balancing method is disclosed that uses a utility's existing transmission and distribution system to charge an Electric Vehicle (EV) using load shifting over time and minimizes the overall cost of energy usage to charge EVs. The collaborative load balancing ensures grid reliability.

### CROSS REFERENCE TO RELATED APPLICATIONS

This application claims the benefit of U.S. Provisional Application No. 61/523,500, filed on Aug. 15, 2011, the disclosure which is incorporated herein by reference in its entirety.

### BACKGROUND OF THE INVENTION

The invention relates generally to electric utility load balancing. More specifically, the invention relates to a method for balancing the electrical load presented when charging Electric Vehicles (EVs).

EVs are becoming increasingly popular. However, the popularity of EVs will result in a strain on the existing electric power transmission and distribution system.

Typical EVs may require 10 to 18 kWh of charge per 100 km. Charging requirements vary by EV, battery technology, battery capacity and charge status. Charging stations, including charging stations installed at residential premises, must be capable of efficiently providing the required amount of current. The maximum amount of power that can be delivered to an electric vehicle is regulated by the Society of Automotive Engineers (SAE). The maximum current that may be supplied to an EV's on-board charger with a branch circuit breaker is 70 A continuous at 208-240 Vac single phase. Therefore, maximum continuous power is 16.8 kVA (240 Vac×70 A).

What is desired is a distributed and collaborative load balancing method that uses a utility's existing transmission and distribution system to charge an Electric Vehicle (EV) using load shifting over time and minimizes the overall cost of energy usage to charge EVs.

### SUMMARY OF THE INVENTION

The inventors have discovered that it would be desirable to provide a distributed and collaborative load balancing method for Electric Vehicle (EV) charging.

One aspect of the invention provides a distributed and collaborative load balancing method that uses a utility's existing transmission and distribution system to charge an Electric Vehicle (EV). Methods according to this aspect of the invention include coupling the EV to an EV charging station at a residence, uploading a total residence power measurement at the residence from a smart meter to a neighborhood charging controller, uploading the EV's battery state-of-charge (SOC), current charging amperage and capacity from the residence to the neighborhood charging controller, uploading a Driving Pattern (DP) for the EV to the neighborhood charging controller, at the neighborhood charging controller, for a neighborhood: calculating a sum of all neighborhood residences' power other than EV consumption, and calculating the energy required for each neighborhood EV from its DP and current SOC, and uploading the residence power sums from one or more neighborhood charging controllers to a substation power controller, calculating a total residence sum at the substation power controller as a substation distribution transformer load, downloading power generation data from a utility control center to the substation power controller, calculating a power threshold from the power generation data, residence load sum and EV energy requirement for each of the one or more neighborhood charging controllers using a first fit algorithm, and downloading each power threshold from the substation power controller to a respective neighborhood charging controllers.

Another aspect of the invention provides at each neighborhood charging controller: calculating available power for EV charging from the neighborhood charging controller's power threshold and the neighborhood energy required to charge each EV, creating a combined status pattern for all the neighborhood EVs, dividing a total timeline into competition intervals by EV departure time wherein each competition interval has a same set of EVs coupled to their EV charging stations, determining available energy for the neighborhood for each competition interval, determining the energy required for a competition interval, and identifying competition intervals that do not have the required energy.

Another aspect of the invention provides for competition intervals identified that do not have the required energy, calculating a ratio of available energy to required energy, calculating a cap on the energy for EV charging, and if in a competition interval there is abundant energy, permitting each EV to receive its required charging amperage based on its DP.

Another aspect of the invention provides at each neighborhood charging controllers: downloading the day ahead energy price from the utility control center, if any competition interval is capped, reducing the amount of charge that will be provided to all the EVs that are scheduled in that competition interval, and if an EV has multiple capping requests for different competition intervals, using a minimum capping.

Another aspect of the invention provides at each neighborhood charging controllers: optimizing the available energy based on the power threshold to allocate power to each EV charging station, downloading the allocated power to each EV charging station and an estimated finish time according to the optimization, and downloading an EV charging station start/stop time to each EV charging station.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is an exemplary diagram of residence, neighborhood and substation levels, and a neighborhood charging controller, a substation power controller and a communications network.

FIG. 2 is an exemplary method,

FIG. 3 is an exemplary user Driving Profile (DP).

### DETAILED DESCRIPTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having,” and variations thereof herein is meant to encompass the items listed thereafter and equivalents thereof as well as additional items.

The terms “connected” and “coupled” are used broadly and encompass both direct and indirect connecting, and coupling. Further, “connected” and “coupled” are not restricted to physical or mechanical connections or couplings.

It should be noted that the invention is not limited to any particular software language described or that is implied in the figures. One of ordinary skill in the art will understand that a variety of alternative software languages may be used for implementation of the invention. It should also be understood that some of the components and items are illustrated and described as if they were hardware elements, as is common practice within the art. However, one of ordinary skill in the art, and based on a reading of this detailed description, would understand that, in at least one embodiment, components in the method and system may be implemented in software or hardware.

Embodiments of the invention provide methods, system frameworks, and a computer-usable medium storing computer-readable instructions that provide a distributed and collaborative load balancing method across a utility's existing transmission and distribution system for Electric Vehicle (EV) charging. Aspects of the load balancing method may be distributed and executed at and on a plurality of computing devices. For example, a Home Energy Manager (HEM), an EV charging station, a utility's Distribution Management System (DMS), a computer, etc. The method is collaborative in terms of resource sharing. Embodiments may be deployed as software as an application program tangibly embodied on a non-transitory computer readable program storage device. The application code for execution can reside on a plurality of different types of computer readable media known to those skilled in the art.

The method load balances EV charging among residents belonging to a neighborhood. A neighborhood is defined as those residences that are electrically sourced from a common distribution transformer. Neighborhood EVs are load balanced by a hardware abstraction referred to as a neighborhood charging controller. The neighborhood charging controller may be physically located at a pole-mounted distribution transformer, a utility control center or other location. Each resident that uses an EV indicates the EV's charging requirement through a user's EV profile or Driving Pattern (DP). One or more neighborhood charging controllers are load balanced by a hardware abstraction referred to as a substation power controller. The substation power controller may be physically located at a substation distribution transformer control room, a utility control center or other location. The substation power controller may also be a part of an existing utility DMS.

Embodiments provide: 1) control of an EV charging station via a hierarchical information flow from a utility control center to an EV charging station. EV charging control is not constrained to specific hardware residing at specific locations, such as a residence, or embedded in another device, such as a home energy gateway, which is similar to a home energy manager. A neighborhood charging controller provides charging control for neighborhood EVs assigned to it. A substation power controller uses a larger view to indirectly control EV charging for the utility. The utility therefore may employ multilevel control to optimize globally, not only locally for few EVs.

2) An EV user's profile, or Driving Pattern (DP), decides its EV charging. The user defines a DP by the distance in miles or kilometers and time until he will start his next trip, and forwards it to his respective neighborhood charging controller.

3) A neighborhood charging controller controls the charging of the EVs and a substation power controller controls the amount of power that a neighborhood charging controller can use to charge its EVs. The substation power controller calculates a power threshold for each neighborhood charging controller (neighborhood distribution transformer). The power threshold is the amount of power that the substation distribution transformer can supply to all of the residences coupled downstream of it. The power threshold is changed for a neighborhood charging controller by the substation power controller changing the physical voltage tap in a neighborhood distribution transformer if employed. The neighborhood distribution transformer is the physical electrical device that provides power, and the neighborhood charging controller is the associated hardware abstraction that controls neighborhood EV charging. A utility's electrical distribution system employs transformers that have variable voltage taps. The variable voltage taps means the power threshold for a neighborhood distribution transformer can be changed without physically changing the transformer. The power threshold available at a neighborhood distribution transformer from a substation power controller may be configured using these taps. Embodiments balance neighborhood EV charging power and balance direct EV charging, indirect charging control by a substation power controller using a configuration of the power threshold of a neighborhood distribution transformer, and indirect charging control by a utility control center using variable electricity pricing.

4) Demand Response (DR) signals forwarded by the substation power controller provide signals for on-demand load shedding for neighborhood charging controllers and residences obligated under a DR policy may receive a DR signal from their neighborhood charging controller when assigned loads are to be shed. The neighborhood charging controller will receive any DR signal, e.g. reduce the load and change the EV charging power accordingly. Change in EV charging power can be performed using the technique of changing the power threshold. The change in power threshold is a periodic event and can only occur in higher time granularity (6-12 hrs.). A DR event provides an event based technique for load balancing that may be used to quickly adapt to any unforeseen event or erratic behavior. Since an EV represents a large electrical load, an EV charging station may be treated separately in a residential scenario from other residential loads. If EV owners have signed up for collaborative EV charging in their neighborhood, then upon receiving a DR signal at the substation distribution transformer level, a substation power controller may indirectly control EV charging and avoid peak loading time. In this manner a utility may avoid peak overloading. When EV users sign up for collaborative charging, the utility acquires information about EV charge requests. Typically, a utility knows the electricity production scenario, weather forecast and the forecasted demand for rest of the loads including HVAC systems. Therefore, by knowing the EV load request during the peak load time, a utility can control the EV charge intelligently. To manage the electricity supply demands, a DR signal in terms of maximum power and/or pricing signal may be sent to the EV users as well. However, to control EV charging automatically from the neighborhood charging controllers in response to a DR command, an agreement between the utility and user must be in place.

5) Embodiments propagate electricity price signals that originate from the utility to an EV user based on demand and electricity production of the grid. During periods when renewable electricity is generated and which is less expensive to produce, it may be used to charge EVs. Therefore, if there is a flexible charging time request (demand) and possibility of variable priced production which is time-variant, then more intelligent EV charging may be accomplished. This can be directly taken into account by neighborhood charging controllers at the neighborhood distribution transformer which can optimize for price if there is enough power to satisfy all users' driving patterns. At the substation distribution transformer level the available current to a particular neighborhood may be determined through this process and therefore more electricity will be provided while the electricity is cheaper and EVs may be charged to full capacity, e.g. 70 A rate per EV during that time. The optimization is for EV charge cost.

By way of background, typical end point electrical distribution delivers power from an electric utility grid to a residence from a neighborhood distribution pole. At the pole or upstream of that pole, may be a pole-mounted single-phase distribution transformer with a three-wire center-tapped secondary winding that provides 120/240 Vac power for residential use.

The 120/240 Vac is distributed to each residence and coupled through an energy, or kilowatt hour (kWh) meter, to the residences' distribution panel. The distribution panel divides the incoming electrical power into circuits for various areas of the residence and provides a protective circuit breaker for each circuit.

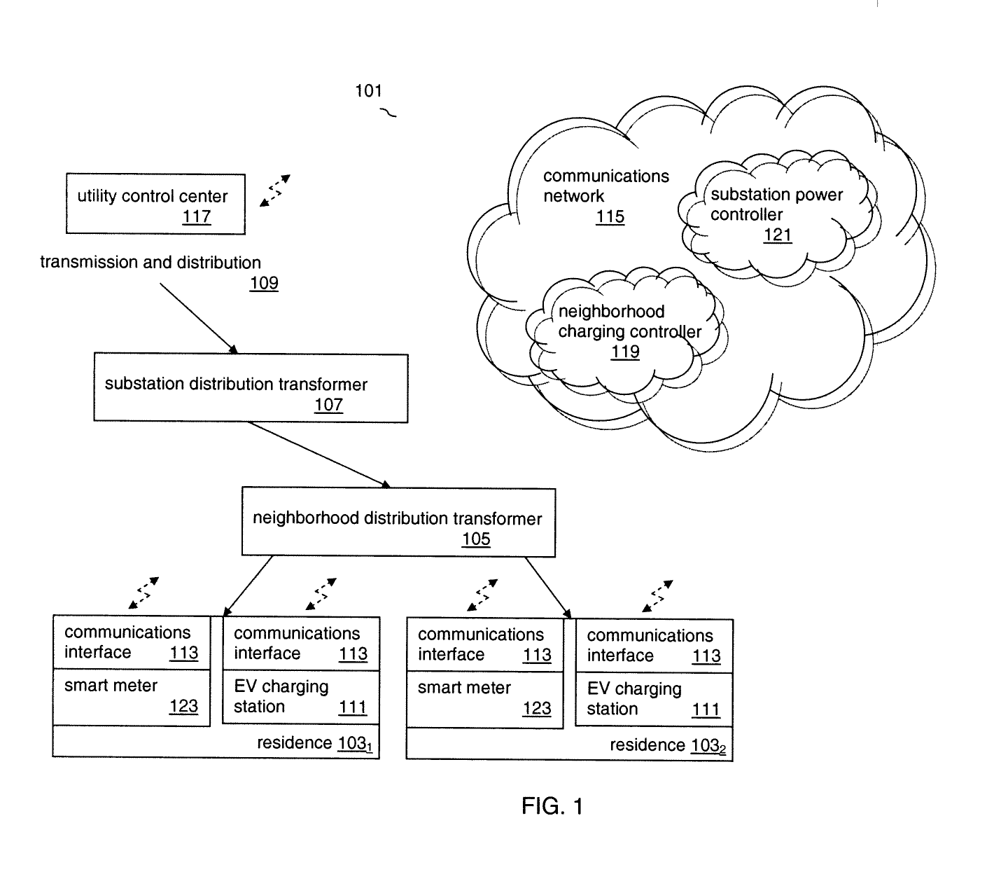

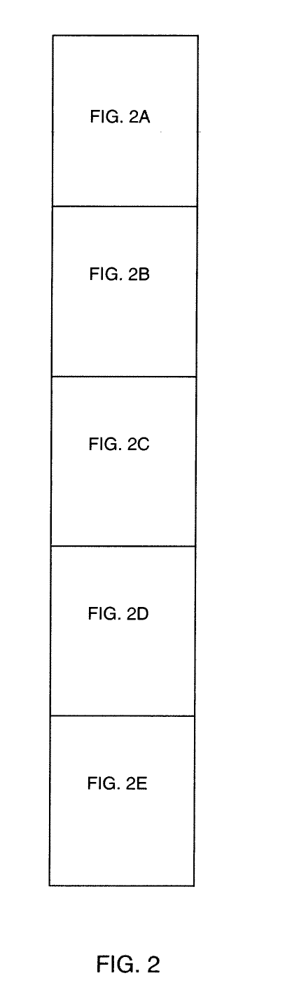

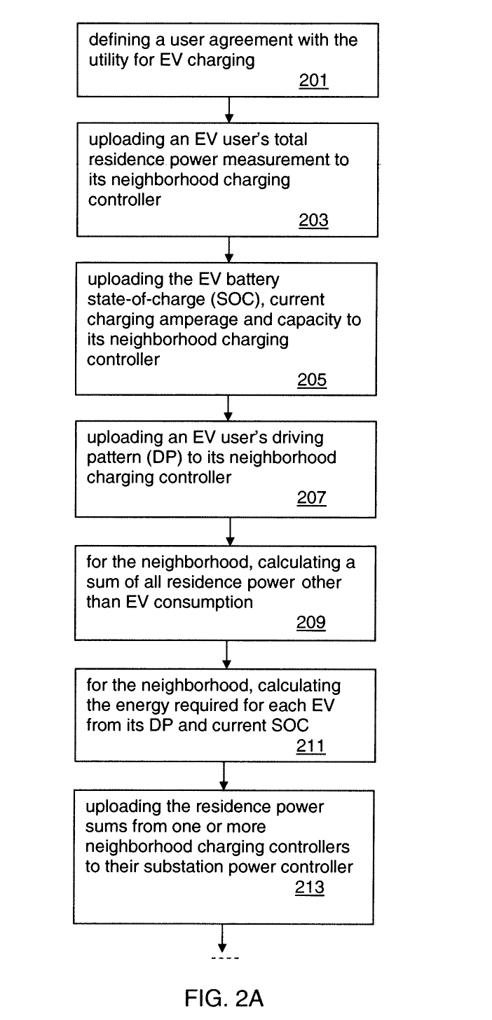

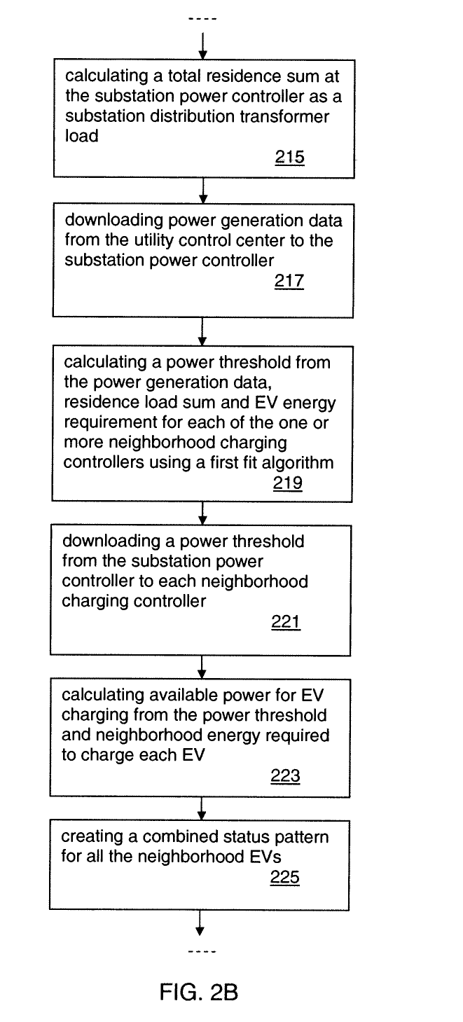

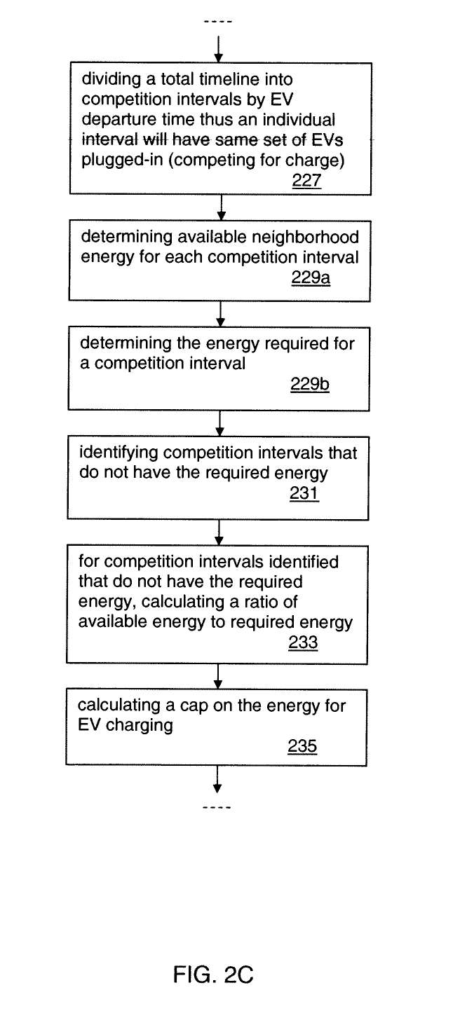

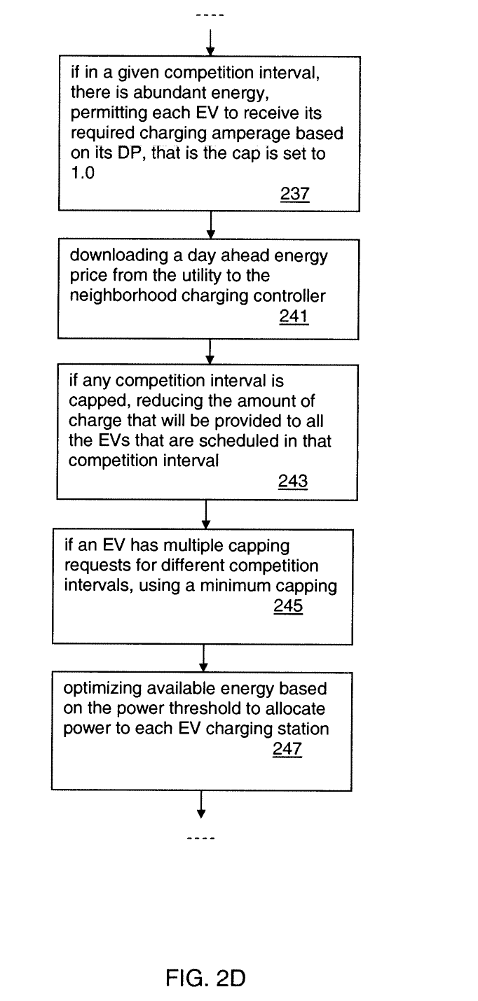

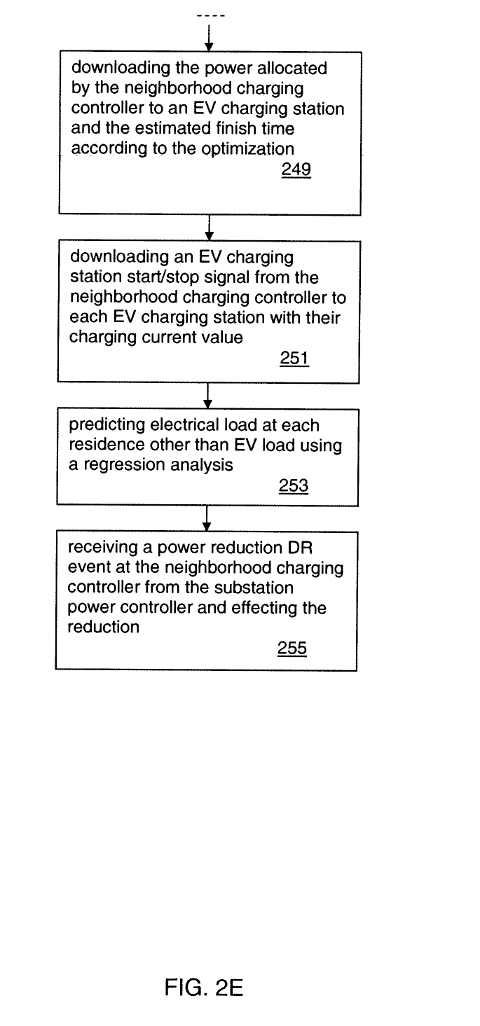

FIG. 1 shows a three level electrical distribution network 101 that includes one or more residences 103₁, 103₂ (collectively 103) which are electrically fed (solid arrows) from a neighborhood distribution transformer 105, which in turn is electrically fed from a substation distribution transformer 107, which in turn is electrically fed from a utility's transmission and distribution system (grid) 109. FIG. 2 is a method. Each residence 103 has an addressable EV charging station 111.

The EV charging station 111 supplies electricity to charge an EV (not shown). Each EV charging station 111 includes a bidirectional communications interface 113 that allows for bidirectional communications (broken arrows) over a communications network 115 to reach an assigned neighborhood charging controller 119.

The bidirectional communications interface 113 may be guided (wired) or unguided (wireless, shown), and communicate over a Local Area Network (LAN), Wireless Fidelity (WiFi), Power Line Communication (PLC) and others, using one or more dedicated protocols, such as Internet Protocol (IP).

Communication is performed using different state-of-the-art protocol. A utility control center 117 and a substation power controller 121 use IP-based communication over Internet. The communication between a substation power controller 121 and a neighborhood charging controller 119 has two alternatives. In the first alternative, the substation power controller 121 and the neighborhood charging controller 119 are hosted in close range and communicate using SEP/Devices Profile for Web Services (DPWS) over WiFi/ZigBee. In the second alternative, the substation power controller 121 and the neighborhood charging controller 119 are hosted at remote locations and communicate over the Internet using IP-based protocol. Communication from a smart meter 123 to the neighborhood charging controller 119 and the communication from the neighborhood charging controller 119 to the EV charging station 111 also have two alternatives. The protocol usage depends on the hosting alternative. IP-based communication is used when they are remotely hosted and communication over WiFi/ZigBee is used when they are hosted in close range. Communication between EV charging station 111 and EV is performed using DPWS over WiFi/ZigBee.

The hardware abstractions of a neighborhood charging controller 119 and substation power controller 121 run load balancing methods for their associated neighborhood distribution transformer 105 and substation distribution transformer 107 levels and report to their higher levels. However, their operating methods are different. A neighborhood charging controller 119 receives a power threshold from its substation power controller 121 and may only provide power to the EVs connected to its associated neighborhood distribution transformer 105. The substation power controller 121 settles the amount of available generation and divides the generated power among one or more neighborhood distribution transformers 105 to match the demand. The substation power controller 121 uses the aggregated demand that is provided by the one or more neighborhood charging controllers 119, receives the generation amount in the future and runs a scheduling algorithm to allocate the available power among the one or more neighborhood distribution transformers 105 to best match the EV charging requirement. The substation power controller 121 communicates a power threshold to its one or more neighborhood charging controllers 119. The aggregated demand used by the substation power controller 121 is uploaded from each neighborhood charging controller 119 and includes the amount of electric load for all the appliances. Loads are grouped by deadline. Loads that have same deadline are one aggregated load. Regular household loads, e.g. lighting, microwave etc., need to be powered whenever they are required and are considered critical and have no deadline. EV loads have flexible deadlines and their load may be shifted from one time to another and still satisfy the deadline. For example, the load to charge an EV will have the amount of electric energy needed to charge the EV along with when the user will start his next trip. The substation power controller 121 uses a greedy first fit approach to perform scheduling. Greedy first fit scheduling takes each demand at a time, and tries to satisfy the demand at a time so that it is met before the deadline adding the least amount of peak demand. Peak demand of a schedule is the amount of load at any time.

The EV charging station 111, whether sourced by 120/240 Vac, is coupled to a distribution panel (not shown) at a residence. To allow embodiments to balance power between residences assigned to a respective neighborhood charging controller 119, a smart meter 123 is employed upstream of the residence's distribution panel. The smart meter 123 includes a communications interface 113 that periodically forwards total residence 103 electrical load (kW) to its assigned neighborhood charging controller 119.

An end user agreement with the utility is defined for EV charging (step 201). The agreement includes guaranteeing a lower price, cash back if there is policy due to saving peak load energy, sharing available power according to the utility's logic among neighbors, etc.

The EV user's total residence 103 power consumption measurement 123 is uploaded to its neighborhood charging controller 118 (step 203).

The EV charging station's 111 operational parameters are uploaded to its neighborhood charging controller 119 (step 205). The operational parameters include the EV's battery State of Charge (SOC), current charging amperage and battery capacity. SOC is expressed as a percentage of current battery charge.

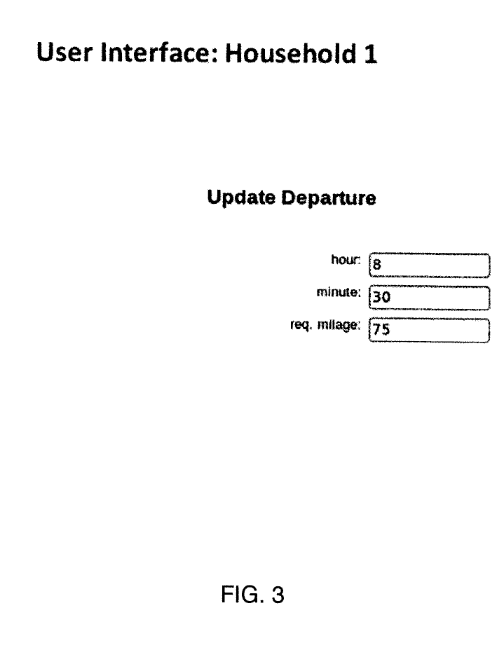

FIG. 3 shows a user's EV profile, or Driving Pattern (DP) having the parameters

DP=<m; dt>, (1)

where m is required mileage and dt is total time for which the EV will be charging. The user updates this data upon arrival at his residence. The departure time indicates after how long the EV will depart which is the total time available for charging. If the user changes his DP from a previous one, the new profile will be taken as a new load with the total charging time being the one just entered. An EV user enters the data using a communications device such as a smartphone via a User Interface (UI) and forwards the data over the communications network 115 to its neighborhood charging controller 119 (step 207).

For a respective neighborhood, the neighborhood charging controller 119 calculates a sum from all resident power measurements (step 209). The neighborhood charging controller 119 receives the residence power measurement for each user (step 203) and the current amperage of all the EVs (step 205). The current amperage is used to calculate the power used to charge an EV. The sum of all residence 103 power minus the power used for EV charging, the neighborhood charging controller 119 calculates the energy needed for EV charging. Other residence loads are not affected by EV charging. The use of residence load sum is twofold. It is uploaded to the substation power controller 121 so that it can be used for future generation planning and it is used to determine how much power can be used to charge EVs. This sum only includes loads other than the EV. So, the power available for charging EVs will be the rest of the power after subtracting the residence power from a power threshold.

The neighborhood charging controller 119 determines the energy requirement for each EV from its DP and current state of charge (SOC) (step 211). Each DP includes next day miles m. The next day miles m provides an estimate, or target, of the level of SOC that is needed to be able to drive the m miles the next day. Once this target SOC level is received, further energy requirement is calculated by subtracting the current SOC from the target SOC. The sum of all these requirements is called the aggregated energy requirement.

The residence power sums from one or more neighborhood charging controllers 119 are uploaded to their assigned substation power controller 121 (step 213). The data includes the current charging profile, which is the aggregated total EV related power consumption and summed residence load at the neighborhood distribution transformer 105. The substation power controller 121 sums the loads from its one or more neighborhood charging controllers 119 as the substation distribution transformer 107 load (step 215). The substation power controller 121 receives data about generation from the utility control center 117 as power generation (step 217). Power generation, substation distribution transformer 107 load and aggregated energy requirement for EVs is used to create a plan for power distribution in future time steps.

The time step used in the substation power controller 121 is multiple hours e.g. 6 hours. The power distribution plan works as follows. The aggregated energy requirement of EVs comes with a deadline. The latest deadline of all the aggregated loads is considered as the end time. The power generation information is received from utility control center until the end time. The household load is subtracted from power generation to obtain available power for EV charging. This available power is used to meet the aggregated EV charging requirement and a power threshold for each neighborhood distribution transformer 105 is determined. The allocation is performed as a first fit basis (step 219). If the substation distribution transformer 107 has two neighborhood distribution transformers 105 downstream, and each associated neighborhood charging controller 119 calculates that it needs 60 kWh within the next 12 hours to charge their respective EVs and the substation distribution transformer 107 has 20 kWh of energy available in each hour, then the substation power controller 121 can allocate 10 kWh to each neighborhood distribution transformer 105 in the next 6 hours. So, the power threshold for each neighborhood distribution transformer 105 will be set to 10 kW in addition to their original household (residence) load.

Each neighborhood charging controller 119 receives a power threshold from the substation power controller 121. The power threshold is the amount of power that a neighborhood distribution transformer 105 can supply to all the households connected to it (step 221). The sum of all household loads and EV charging loads cannot exceed the power threshold.

The neighborhood charging controller 119 uses the DP of each EV user in its neighborhood to create a combined status pattern for all neighborhood EVs (steps 223, 225). The combined status pattern includes identification of EVs, current battery status and DP. If an EV user forgets to update his DP for his next trip, the neighborhood charging controller 119 uses his last DP.

The neighborhood charging controller 119 calculates the power available to charge its EVs by subtracting the summed household load (other than EV) power from its power threshold (step 223).

Embodiments execute two sequences at each neighborhood charging controller 119 at regular time slots (e.g. 15 minutes). The first sequence is feasibility verification. Feasibility verification shows if an EV may be charged according to its DP.

During feasibility verification, a timeline is divided into competition intervals so that an individual interval has same set of EVs that are competing for charge (step 227). If there are three EVs connected to a neighborhood distribution transformer 105 and their departure time is 6 AM, 8 AM and 9 AM, respectively, then there are three competition intervals. The first competition interval is from present time until 6 AM when all three EVs want to charge. The second competition interval is from 6 AM to 8 AM when two EVs want to charge. The third competition interval is from 8 AM to 9 AM. Therefore, there will be no arrival or departure of EVs within a single competition interval. For each competition interval, the neighborhood charging controller 119 calculates the energy available for that interval (step 229a). The total competition interval is divided into smaller time slots e.g. 15 minutes. The available power during a time slot is the power threshold provided by the substation power controller 121 minus a forecasted load during that time slot. Load forecasting is beyond the scope of this disclosure. Regression based load forecasting is in the prior art. The energy of a time slot is power multiplied by the length of the time slot. The available power of a competition interval is the sum of energy required by all time slots within the competition interval.

The neighborhood charging controller 119 determines the energy required for each competition interval (step 229b). Each competition interval is ended when one or more EV is supposed to depart. So, the required energy of a competition interval is the amount of energy needed to charge all EVs departing before the end time of the competition interval. The charge required by an EV depends on its SOC and next day miles. The mapping from miles to required energy is beyond the scope of this disclosure. Available power and required power for each competition interval is examined, and competition intervals that have less energy than required are identified (step 231).

For competition intervals that do not have the required energy, a ratio of available energy to required energy is calculated, and the ratio is used to calculate the capping amount of the energy allocated to the EVs sourced by the neighborhood distribution transformer 105 (steps 233, 235). The ratio is associated and stored with a competition interval. The ratio is enforced when power is allocated in corresponding competition intervals.

If in a given competition interval there is abundant energy, the feasibility verification permits each EV to receive their required charging amperage based on their DP i.e. the cap is set to 1.0 (step 237).

The day-ahead electricity price is downloaded from the utility control center 117 to the neighborhood charging controller 119 (step 241). The neighborhood charging controller 119 uses capping set to any competition interval to reduce the amount of charge that will be provided to the EVs that are present in that competition interval (step 243). If an EV has several caps from several intervals, the neighborhood charging controller 119 will use the minimum cap (step 245). The power allocation sequence allocates available power sourced by a neighborhood distribution transformer 105 to the EVs.

Power allocation may be performed using linear programming optimization,

minimize: ΣₜΣᵤΣᵢPₜ×aᵤᵢₜ×V×Δt, (2)

subject to: ΣᵤΣᵢaᵤᵢₜ×V≦Aₜ−Hₜ ∀t∈[0,T], (3)

Σₜaᵤᵢₜ×V×Δt≧Dᵤᵢ ∀i∈εᵤ, (4)

aᵤᵢₜ=0 ∀t∉[Sᵤᵢ,Rᵤᵢ) and (5)

aᵤᵢₜ∈{0,6−70} ∀u,i,t, (6)

where u is the set of all users, εᵤ is the set of all EVs of user u, V is the distribution voltage, Pₜ is the price of electricity at time t (in dollars per Watts), Aₜ is the threshold for the neighborhood distribution transformer at time t (in Watts), Hₜ is the sum of residence load at time t (in Watts), Dᵤᵢ is the energy required of the ith EV of user u (in Watt-hours), Sᵤᵢ is the arrival/start time of the ith car of user u, Rᵤᵢ is the departure/end time from the EV charging station of the ith car of user u, aᵤᵢₜ is the amperage allotted to the ith EV of user u at time t (in Amps), Δt is the length of time slots (in hours) and T is the total number of time slots.

Optimization is performed to achieve minimum cost. If there is enough energy to charge all the EVs, then minimum cost is sought. Otherwise, all the energy will be used and not every EV will be charged according to their DP (step 247). After the power allocation has been decided, the neighborhood charging controller 119 sends the amount of allocated power to each EV charging station (step 249). The EV charging station will ensure that the allocated amount of power is drawn by its EV. Each EV charging station 111 only receives its own allocated power. The estimated finish time of the charging is also received from the neighborhood charging controller 119 to an EV charging station 111. The EV charging station 111 sends the signal to its EV to charge if power has been allocated by the neighborhood charging controller 119 (step 251).

The method depends on accurate load prediction. Electric utilities use load prediction methodologies that employ regression to predict load (step 253). Any load prediction algorithm may be used together with the neighborhood charging controller 119. Load prediction is beyond the scope of this disclosure. Moreover, EVs arriving late can affect already plugged-in EV.

The method can successfully schedule all EVs associated with a neighborhood charging controller 119 so each vehicle receives an allocated amount of power in any competition interval.

The neighborhood charging controller 119 receives any DR event from substation power controller acts accordingly (step 255). The presence of a DR event and action on a DR event depends on the actual contract between a neighborhood charging controller 119 and a substation power controller 121. Some exemplary DR events are reduce load by 10%, reduce power consumption to 10 kW, etc.

One or more embodiments of the present invention have been described. Nevertheless, it will be understood that various modifications may be made without departing from the spirit and scope of the invention. Accordingly, other embodiments are within the scope of the following claims.

What is claimed is:

1. A distributed and collaborative load balancing method that uses a utility's existing transmission and distribution system to charge an Electric Vehicle (EV) comprising:
coupling the EV to an EV charging station at a residence;
uploading a total residence power measurement at the residence from a smart meter to a neighborhood charging controller;
uploading the EV's battery state-of-charge (SOC), current charging amperage and capacity from the residence to the neighborhood charging controller;
uploading a Driving Pattern (DP) for the EV to the neighborhood charging controller;
at the neighborhood charging controller, for a neighborhood:
calculating a sum of all neighborhood residences' power other than EV consumption; and
calculating the energy required for each neighborhood EV from its DP and current SOC; and
uploading the residence power sums from one or more neighborhood charging controllers to a substation power controller;
calculating a total residence sum at the substation power controller as a substation distribution transformer load;
downloading power generation data from a utility control center to the substation power controller;
calculating a power threshold from the power generation data, residence load sum and EV energy requirement for each of the one or more neighborhood charging controllers using a first fit algorithm; and
downloading each power threshold from the substation power controller to a respective neighborhood charging controllers.

2. The method according to claim 1 further comprising:
at each neighborhood charging controller:
calculating available power for EV charging from the neighborhood charging controller's power threshold and the neighborhood energy required to charge each EV;
creating a combined status pattern for all the neighborhood EVs;
dividing a total timeline into competition intervals by EV departure time wherein each competition interval has a same set of EVs coupled to their EV charging stations;
determining available energy for the neighborhood for each competition interval;
determining the energy required for a competition interval; and
identifying competition intervals that do not have the required energy.

3. The method according to claim 2 further comprising:
for competition intervals identified that do not have the required energy, calculating a ratio of available energy to required energy;
calculating a cap on the energy for EV charging; and
if in a competition interval there is abundant energy, permitting each EV to receive its required charging amperage based on its DP.

4. The method according to claim 3 further comprising:
at each neighborhood charging controllers:
downloading the day ahead energy price from the utility control center;
if any competition interval is capped, reducing the amount of charge that will be provided to all the EVs that are scheduled in that competition interval; and
if an EV has multiple capping requests for different competition intervals, using a minimum capping.

5. The method according to claim 4 further comprising:
at each neighborhood charging controllers:
optimizing the available energy based on the power threshold to allocate power to each EV charging station;
downloading the allocated power to each EV charging station and an estimated finish time according to the optimization; and
downloading an EV charging station start/stop time to each EV charging station.

6. The method according to claim 5 further comprising predicting electrical load at each residence other than EV load using a regression analysis.

7. The method according to claim 6 further comprising receiving a power reduction DR event at the one or more neighborhood charging controllers from the substation power controller.

8. The method according to claim 7 further comprising defining an agreement with the utility for EV charging.

9. A non-transitory computer readable medium having recorded thereon a computer program comprising code means for, when executed on a computer, instructing the computer to control steps in a distributed and collaborative load balancing method that uses a utility's existing transmission and distribution system to charge an Electric Vehicle (EV), the method comprising:
coupling the EV to an EV charging station at a residence;
uploading a total residence power measurement at the residence from a smart meter to a neighborhood charging controller;
uploading the EV's battery state-of-charge (SOC), current charging amperage and capacity from the residence to the neighborhood charging controller;
uploading a Driving Pattern (DP) for the EV to the neighborhood charging controller;
at the neighborhood charging controller, for a neighborhood:
calculating a sum of all neighborhood residences' power other than EV consumption; and
calculating the energy required for each neighborhood EV from its DP and current SOC; and
uploading the residence power sums from one or more neighborhood charging controllers to a substation power controller;
calculating a total residence sum at the substation power controller as a substation distribution transformer load;
downloading power generation data from a utility control center to the substation power controller;
calculating a power threshold from the power generation data, residence load sum and EV energy requirement for each of the one or more neighborhood charging controllers using a first fit algorithm; and
downloading each power threshold from the substation power controller to a respective neighborhood charging controllers.

10. The non-transitory computer readable medium according to claim 9 further comprising:
at each neighborhood charging controller:
calculating available power for EV charging from the neighborhood charging controller's power threshold and the neighborhood energy required to charge each EV;
creating a combined status pattern for all the neighborhood EVs;
dividing a total timeline into competition intervals by EV departure time wherein each competition interval has a same set of EVs coupled to their EV charging stations;
determining available energy for the neighborhood for each competition interval;
determining the energy required for a competition interval; and
identifying competition intervals that do not have the required energy.

11. The non-transitory computer readable medium according to claim 10 further comprising:
for competition intervals identified that do not have the required energy, calculating a ratio of available energy to required energy;
calculating a cap on the energy for EV charging; and
if in a competition interval there is abundant energy, permitting each EV to receive its required charging amperage based on its DP.

12. The non-transitory computer readable medium according to claim 11 further comprising:
at each neighborhood charging controllers:
downloading the day ahead energy price from the utility control center;
if any competition interval is capped, reducing the amount of charge that will be provided to all the EVs that are scheduled in that competition interval; and
if an EV has multiple capping requests for different competition intervals, using a minimum capping.

13. The non-transitory computer readable medium according to claim 12 further comprising:
at each neighborhood charging controllers:
optimizing the available energy based on the power threshold to allocate power to each EV charging station;
downloading the allocated power to each EV charging station and an estimated finish time according to the optimization; and
downloading an EV charging station start/stop time to each EV charging station.

14. The non-transitory computer readable medium according to claim 13 further comprising predicting electrical load at each residence other than EV load using a regression analysis.

15. The non-transitory computer readable medium according to claim 14 further comprising receiving a power reduction DR event at the one or more neighborhood charging controllers from the substation power controller.

16. The non-transitory computer readable medium according to claim 15 further comprising defining an agreement with the utility for EV charging.
